(19) United States
(12) Patent Application Publication
(10) Pub. No.: US 2020/0192058 A1
(43) Pub. Date: Jun. 18, 2020

(54) MIRROR DEVICE

(71) Applicant: TOSHIBA TEC KABUSHIKI KAISHA, Tokyo (JP)

(72) Inventor: Atsushi MIYASHIMA, Izunokuni Shizuoka (JP)

(73) Assignee: TOSHIBA TEC KABUSHIKI KAISHA, Tokyo (JP)

(21) Appl. No.: 16/217,594

(22) Filed: Dec. 12, 2018

(51) Int. Cl. G02B 7/182; G03G 15/043

(52) U.S. Cl. CPC G02B 7/182; G03G 15/0435

(57) ABSTRACT

A mirror device includes a mirror, a base member, a fixing unit, a biasing mechanism, and a movement mechanism. The mirror has an elongated shape including a reflective surface. The base member has an elongated shape disposed on a back side opposite to the reflective surface. The fixing unit fixes a portion of the mirror excluding the reflective surface to both ends of the base member in a lengthwise direction. The biasing mechanism is disposed on the back side of the mirror and biases the mirror towards the base member. The movement mechanism is disposed on the back side of the mirror and moves the mirror in a direction away from the base member.

### FIELD

Embodiments described herein relate generally to a mirror device.

### BACKGROUND

In an image forming device, a mirror device is used to correct the bending of laser scanning line. The mirror device bendably deforms the mirror by applying an external force to correct the bending of the laser scanning line. At this time, when the point of force, or fulcrum of the external force is placed on the reflective surface of the mirror, the usable area of the reflective surface of the mirror is narrowed. A mirror device is required which is capable of securing a wider usable area of the reflective surface of the mirror.

### DESCRIPTION OF THE DRAWINGS

FIG. 1 is a view schematically illustrating an image forming device;

FIG. 2 is a front sectional view of a laser scanning unit;

FIG. 3 is a plan view of the laser scanning unit;

FIG. 4 is a side view of a mirror device according to at least one exemplary embodiment;

FIG. 5 is a perspective view of the mirror device;

FIG. 6 is an exploded perspective view of the mirror device;

FIG. 7 is an enlarged view of a VII part of FIG. 5;

FIG. 8 is an enlarged view of a VIII part of FIG. 6;

FIG. 9 is an enlarged view of a IX part of FIG. 5;

FIG. 10 is a first explanation diagram of a correction operation on the bending of laser scanning line; and

FIG. 11 is a second explanation diagram of the correction operation.

### DETAILED DESCRIPTION

In general, according to some embodiments, a mirror device includes a mirror, a base member, a fixing unit, a biasing mechanism, and a movement mechanism. The mirror has an elongated shape including a reflective surface. The base member has an elongated shape disposed on a back side opposite to the reflective surface. The fixing unit fixes a portion of the mirror excluding the reflective surface to both ends of the base member in a lengthwise direction. The biasing mechanism is disposed on the back side of the mirror and biases the mirror towards the base member. The movement mechanism is disposed on the back side of the mirror and moves the mirror in a direction away from the base member.

Hereinafter, a mirror device of some embodiments will be described with reference to the drawings.

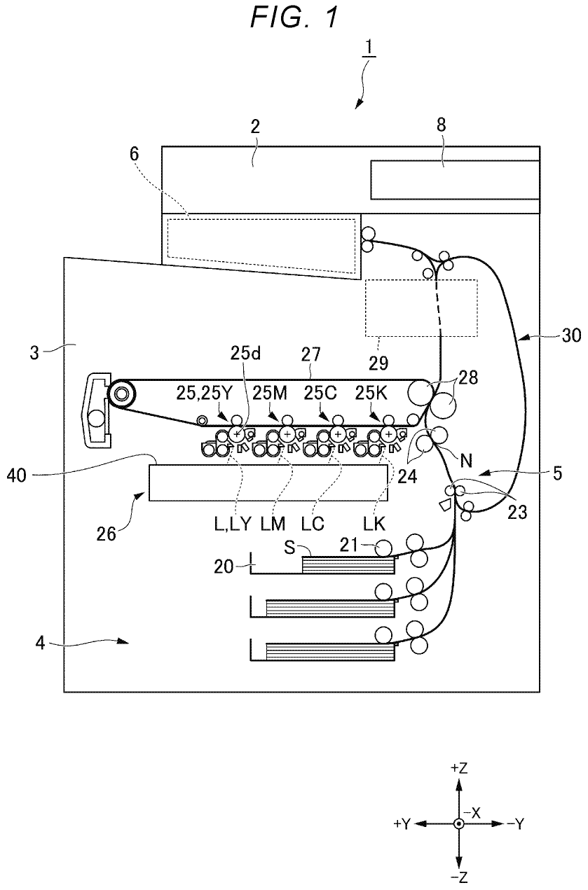

FIG. 1 is a view schematically illustrating an image forming device.

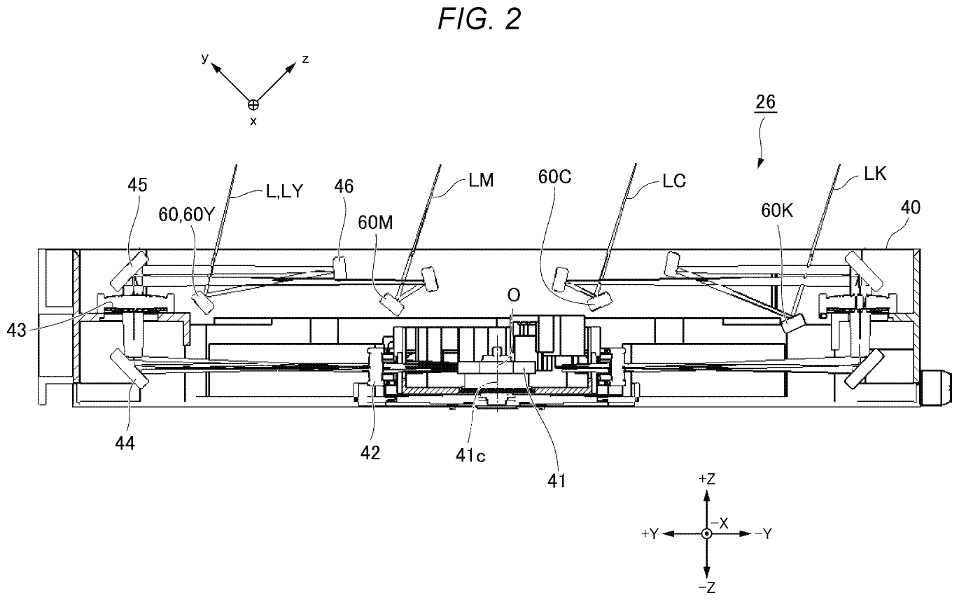

For the overall coordinate system of the image forming device 1, X direction, Y direction and Z direction are defined as follows. The X direction is an axial direction of a photosensitive drum 25d of an image forming part 25. The +X direction is an inward direction of the image forming device 1 (into the drawing sheet of FIG. 1). The Y direction is a direction in which the photosensitive drums 25d of a plurality of image forming parts 25Y, 25M, 25C, 25K are aligned. The +Y direction is a right-side direction when facing the image forming device 1. The origin of the X and the Y directions is positioned at a central axis 41c of a polygon mirror 41 (see FIG. 2). The Z direction is a vertical direction, in which the +z direction is an upward direction.

As shown in FIG. 1, the image forming device 1 includes a control panel 8, a scanner part 2, a printer part 3, a sheet feeding part 4, a conveying part 5, and a control part 6.

The control panel 8 is a part of an input part through which an operator inputs information for operating the image forming device 1. The control panel 8 may have a touch panel or various hard keys.

The scanner part 2 reads the image information of an object to be copied with the contrast of light. The scanner part 2 outputs the read image information to the printer part 3.

The printer part 3 forms an output image (hereinafter referred to as a ‘toner image’) with a developer including toner, or the like, based on the image information read by the scanner part 2 or the image signal from outside. The printer part 3 transfers the toner image onto a surface of a paper sheet S. The printer part 3 applies heat and pressure to the toner image on the surface of the sheet S to fix the toner image onto the sheet S.

The sheet feeding part 4 feeds the sheets S one by one to the conveying part 5 in accordance with the timing at which the printer part 3 forms a toner image. The sheet feeding part 4 includes a paper cassette 20 and a pickup roller 21.

The paper cassette 20 accommodates a predetermined size and type of sheet S.

The pickup roller 21 picks up the sheets S one by one from the paper cassette 20. The pickup roller 21 feeds the picked sheet S to the conveying part 5.

The conveying part 5 conveys the sheet S fed from the sheet feeding part 4 to the printer part 3. The conveying part 5 includes a conveying roller 23 and a regist roller 24.

The conveying roller 23 conveys the sheet S fed from the pickup roller 21 to the regist roller 24. The conveying roller 23 allows the leading end of the sheet S in the conveyance direction to contact the nip N of the regist roller 24. The conveying roller 23 adjusts the position of the leading end of the sheet S in the conveying direction by bending the sheet S.

The regist roller 24 aligns the leading end of the sheet S with the nip N. The regist roller 24 conveys the sheet S according to the timing when the printer part 3 transfers the toner image onto the sheet S.

The control part 6 controls the respective parts of the image forming device 1.

An arrangement of the printer part 3 will be described. The printer part 3 includes a plurality of image forming parts 25, a laser scanning unit 26, an intermediate transfer belt 27, a transfer part 28, a fuser 29, and a reversal unit 30.

The image forming part 25 includes a photosensitive drum 25d. The image forming part 25 forms a toner image on the photosensitive drum 25d in accordance with image signals from the scanner unit 2 or from outside. A plurality of image forming parts 25Y, 25M, 25C and 25K form toner images with the yellow, magenta, cyan, and black toners, respectively.

Around the photosensitive drum 25d, a charging device, a developing device, and the like are disposed. The charging device charges the surface of the photosensitive drum 25d. The developing device accommodates a developer including yellow, magenta, cyan, and black toners. The developing device develops the electrostatic latent image on the photosensitive drum 25d. As a result, the toner image is formed on the photosensitive drum 25d by the respective colored toners.

The laser scanning unit 26 scans the charged photosensitive drum 25d with a laser beam L to expose the photosensitive drum 25d, thereby forming an electrostatic latent image. The laser scanning unit 26 exposes each of the photosensitive drums 25d of the image forming parts 25Y, 25M, 25C, 25K to the respective laser beams LY, LM, LC, LK. The laser scanning unit 26 is disposed under the charging device and developing device. The laser scanning unit 26 will be described later.

The toner image on the surface of the photosensitive drum 25d is primarily transferred to the intermediate transfer belt 27.

The transfer part 28 transfers the toner image primarily transferred onto the intermediate transfer belt 27 onto the surface of the sheet S in a secondary transfer position.

The fuser 29 applies heat and pressure to the sheet S and fixes the transferred toner image on the sheet S. For the fuser according to some embodiments, a method of fixing the toner image on the sheet S by heating through a film-type member may be applied.

The reversal unit 30 reverses the sheet S to form an image on the back side of the sheet S. The reversal unit 30 reverses, by switchback, the front and back sides of the sheet S ejected from the fuser 29. The reversal unit 30 conveys the reversed sheet S toward the regist roller 24.

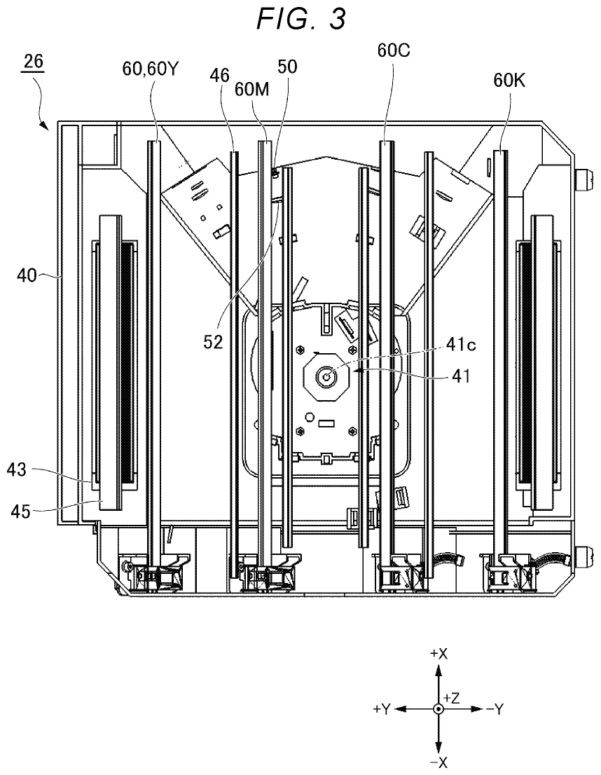

The laser scanning unit 26 will be described below. FIG. 2 is a front sectional view of the laser scanning unit 26. FIG. 3 is a plan view of the laser scanning unit 26. As shown in FIG. 2, the laser scanning unit 26 scans the laser beam L of the photosensitive drum of the image forming part to expose the photosensitive drum. The laser scanning unit 26 scans the photosensitive drums of the image forming parts of respective colors by the respective laser beams LY, LM, LC, and LK. The laser scanning unit 26 includes respective color optical systems for scanning the laser beams LY, LM, LC, and LK. The respective color optical systems includes a yellow optical system that scans the laser beam LY, a magenta optical system that scans the laser beam LM, a cyan optical system that scans the laser beam LC, and a black optical system that scans the laser beam LK. The respective color optical systems are disposed on both sides in the Y direction of the polygon mirror 41. The yellow optical system and the magenta optical system are disposed in the +Y direction of the polygon mirror 41. The cyan optical system and the black optical system are disposed in the −Y direction of the polygon mirror 41. Hereinafter, embodiments will be described with reference to the yellow optical system as a representative example.

As shown in FIG. 3, the laser scanning unit 26 includes a housing 40, a laser beam source 50, and a writing optical system.

The laser beam source 50 is disposed at a lower portion of the housing 40 in the Z direction. The laser beam source 50 is disposed in the +X direction of the polygon mirror 41. Each of the color optical systems includes the laser beam source 50. Each laser beam source 50 sequentially irradiates a laser beam.

As shown in FIG. 2, the writing optical system includes the polygon mirror 41, various reflection mirrors, and various f-theta (fθ) lenses.

The polygon mirror 41 is disposed at a lower portion of the housing 40 in the Z direction. The polygon mirror 41 is disposed in the center of the housing 40 in the X direction and the Y direction. The polygon mirror 41 is formed in a flat polygonal plate shape and disposed in parallel with the bottom surface of the housing 40. The polygon mirror 41 is formed such that it is rotatable around a central axis 41c parallel to the Z direction. A reflective surface is formed on a side of the polygon mirror 41. The polygon mirror 41 reflects the laser beam L from the laser beam source 50 toward the first reflection mirror 44. The polygon mirror 41 scans the laser beam L by reflecting the laser beam L while rotating around the central axis 41c. The respective color optical systems shares one polygon mirror 41. The polygon mirror 41 sequentially reflects the respective laser beams LY, LM, LC, and LK from the respective laser beam sources 50 while rotating around the center axis 41c.

As shown in FIG. 3, a collimator lens 52 and a cylindrical lens (not shown) are disposed between the laser beam source 50 and the polygon mirror 41.

As shown in FIG. 2, various reflection mirrors include a first reflection mirror 44, a second reflection mirror 45, a third reflection mirror 46, and a final reflection mirror 60. The various reflection mirrors are formed in an elongated shape, with the lengthwise direction corresponding to the X direction. The various reflection mirrors sequentially reflect the laser beams L emitted from the polygon mirror 41 so that the beams fall onto the photosensitive drum. The various reflection mirrors are disposed in a layout in which the optical path lengths of the respective color optical systems are the same.

The first reflection mirror 44 is disposed at a lower portion of the housing 40 in the Z direction. The first reflection mirror 44 is disposed at an end of the housing 40 in the +Y direction.

The second reflection mirror 45 is disposed at an upper portion of the housing 40 in the Z direction. The second reflection mirror 45 is disposed at an end of the housing 40 in the +Y direction.

The yellow optical system and the magenta optical system share the first reflection mirror 44 and the second reflection mirror 45 disposed in the +Y direction of the polygon mirror 41. The cyan optical system and the black optical system share the first reflection mirror and the second reflection mirror disposed in the −Y direction of the polygon mirror 41.

The third reflection mirror 46 is disposed at an upper portion of the housing 40 in the Z direction. The third reflection mirror 46 is disposed in the −Y direction of the second reflection mirror 45.

The final reflection mirror (tilt mirror) 60 is disposed in the −Z direction of the third reflection mirror 46. The final reflection mirror 60 is disposed in the +Y direction of the second reflection mirror 45.

Each of the color optical systems includes the third reflection mirror 46 and the final reflection mirror 60, respectively.

A various fθ lenses include a first fθ lens 42 and a second fθ lens 43. The various fθ lenses are formed in an elongated shape, with the X direction as the lengthwise direction. The various fθ lenses converge the laser beam L into a predetermined spot diameter on the image plane. The various fθ lenses impart fθ characteristics to the laser beam L such that the laser beam L scans the image plane at a uniform speed when the polygon mirror 41 rotates at a constant speed.

The first fθ lens 42 is disposed between the polygon mirror 41 and the first reflection mirror 44.

The second fθ lens 43 is disposed between the first reflection mirror 44 and the second reflection mirror 45.

The yellow optical system and the magenta optical system share the first fθ lens 42 and the second fθ lens 43 disposed in the +Y direction of the polygon mirror 41. The cyan optical system and the black optical system share the first fθ lens and the second fθ lens disposed in the −Y direction of the polygon mirror 41.

The mirror device of the embodiment is applied to the final reflection mirror 60 (60Y, 60M, 60C, and 60K) of respective color optical systems.

The mirror device 60 according to the embodiment will be described in detail below.

For the local coordinate system of the mirror device 60, X direction, Y direction and Z direction are defined as follows. The x direction is the lengthwise direction of a mirror 62 of the mirror device 60. The y direction is the short direction of the mirror 62. The z direction is the thickness direction of mirror 62. The +z direction is the direction from the back side 62b toward the reflective surface 62r of the mirror 62.

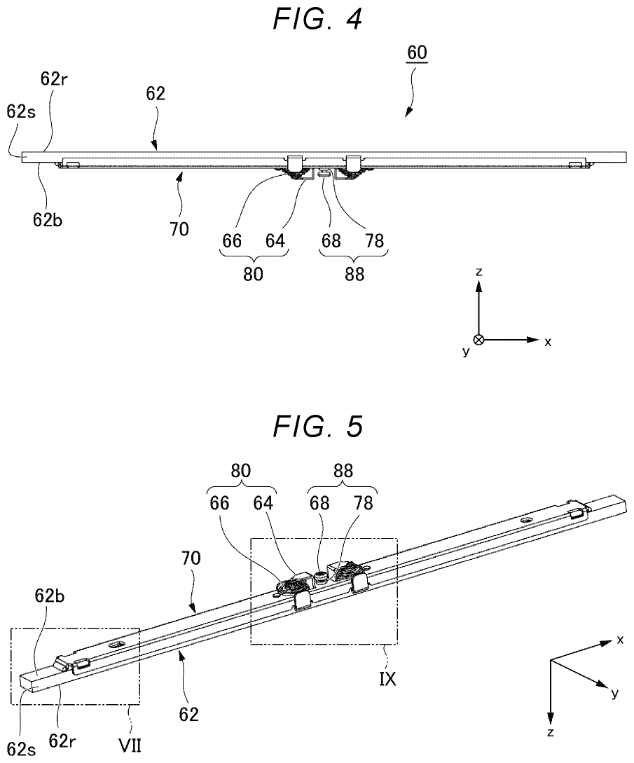

FIG. 4 is a side view of the mirror device 60 according to the embodiment. FIG. 5 is a perspective view of the mirror device 60. The mirror device 60 includes a mirror 62, a base member 70, a fixing unit 73, a biasing mechanism 80, and a movement mechanism 88.

The mirror 62 is formed in an elongated shape (strip shape) extending in the x direction. The mirror 62 includes a reflective surface 62r in the +z direction. The mirror 62 includes a back side 62b in the −z direction opposite to the reflective surface 62r. The mirror 62 includes a side 62s between the reflective surface 62r and the back side 62b. The mirror device 60 is fixed to the housing of the laser scanning unit at both ends in the x direction of the mirror 62.

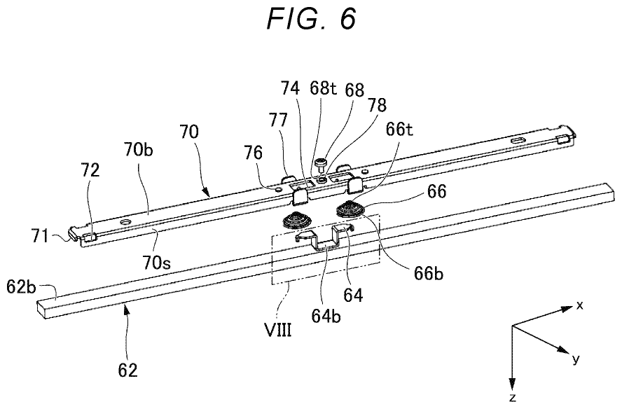

FIG. 6 is an exploded perspective view of a mirror device according to some embodiments.

The base member 70 is formed in an elongated shape extending in the x direction. The base member 70 is formed by press working a steel sheet material. The base member 70 is formed such that it has a U-shaped cross-section perpendicular to the x direction. The base member 70 includes a substrate 70b and a pair of widthwise bent portions 70s (second bent portions). The substrate 70b is disposed parallel to the xy plane. The pair of widthwise bent portions 70s are bent from both ends of the substrate 70b in the y direction (width direction) toward the +z direction (mirror 62 side). The pair of widthwise bent portions 70s are disposed parallel to the xz plane.

The base member 70 is disposed in the −z direction of the mirror 62. The substrate 70b of the base member 70 is disposed opposite to the back side 62b of the mirror 62.

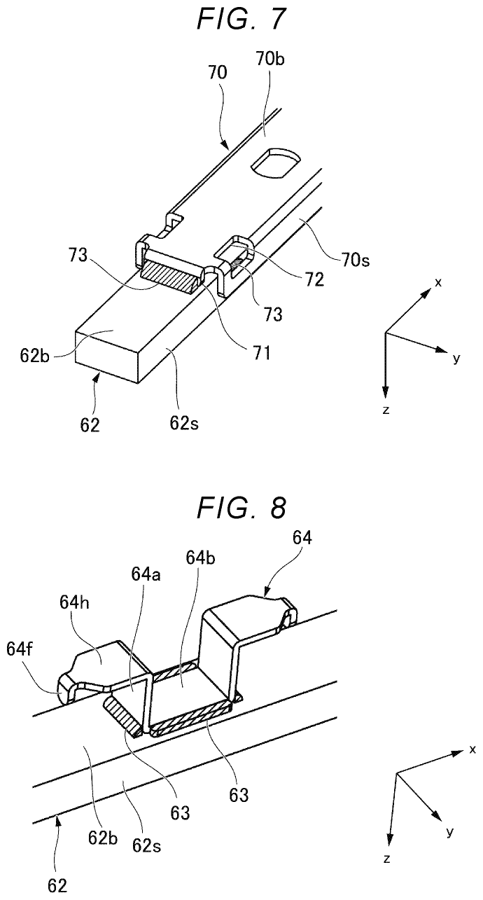

FIG. 7 is an enlarged view of a VII part of FIG. 5.

The base member 70 includes lengthwise bent portions (first bent portions) 71 on both ends in the x direction, which are bent in the +z direction (mirror 62 side). The leading end of the lengthwise bent portion 71 abuts against the back side 62b of the mirror 62. As a result, the substrate 70b of the base member 70 is disposed away from the back side 62b of the mirror 62 by the height of the lengthwise bent portion 71 in the z direction.

The distance in the y direction of the pair of widthwise bent portions 70s of the base member 70 is larger than the width of the mirror 62 in the y direction. When viewed from the y direction, the leading end of the widthwise bent portion 70s of the base member 70 overlaps with the side 62s of the mirror 62. As a result, in the cross-section of the base member 70 perpendicular to the x direction, the second moment of area increases. The second moment of area of the cross-section perpendicular to the x direction is larger in the base member 70 than in the mirror 62. Accordingly, the bending stiffness around the z axis is greater in the base member 70 than in the mirror 62.

The fixing unit 73 is disposed on both ends of the base member 70 in the x direction. For example, the fixing unit 73 is formed of a photo-curable adhesive such as epoxy resin. The fixing unit 73 fixes a portion of the mirror 62 excluding the reflective surface 62r to both ends of the base member 70 in the x direction. The fixing unit 73 fixes the back side 62b of the mirror 62 and the lengthwise bent portion 71 of the base member 70. The fixing unit 73 fixes the side 62s of the mirror 62 with the widthwise bent portion 70s of the base member 70. In addition, a window portion 72 is formed at the corner between the substrate 70b and the widthwise bent portion 70s of the base member 70. Through this window portion 72, a fixing unit 73 is formed between the side 62s of the mirror 62 and the widthwise bent portion 70s of the base member 70.

The adhesive used for the fixing unit 73 is an elastomer that has a small elastic modulus after curing. As a result, minute displacement of the mirror 62 in the x direction with respect to the base member 70 is allowed, thereby bendably deforming the mirror 62 which will be described below. In addition, the adhesive has heat resistance so that peel-off does not occur even when heating is repeated. As a result, in the interior of the image forming apparatus in which heating is repeated, fixation between the base member 70 and the mirror 62 is maintained.

As shown in FIGS. 4 and 5, the biasing mechanism 80 is disposed in the direction of the back side 62b of the mirror 62. The biasing mechanism 80 biases the mirror 62 in the −y direction (the direction towards the base member 70). The biasing mechanism 80 includes an intermediate member 64, and a pair of coil springs 66 which are biasing members.

FIG. 8 is an enlarged view of a VIII part of FIG. 6. The intermediate member 64 is formed by press working a steel sheet material. The intermediate member 64 includes a bottom plate portion 64b, a pair of arm portions 64a, a pair of hand portions 64h, and a pair of fingertip portions 64f.

The bottom plate portion 64b is disposed along the back side 62b of the mirror 62.

The pair of arm portions 64a extend in the −z direction from both ends of the bottom plate portion 64b in the x direction.

The pair of hand portions 64h extend, from the leading ends of the pair of arm portions 64a in the −z direction, toward the outer sides of the pair of arm portions 64a in the x direction (in a direction away from each other).

The pair of fingertip portions 64f extends from the leading ends of the pair of hand portions 64h in the x direction, toward the mirror 62 and the base member 70 in the +z direction.

The intermediate member 64 is fixed to the back side 62b of the mirror 62 by the adhesive 63, or the like. The adhesive 63 is disposed around the bottom plate portion 64b. The intermediate member 64 maybe fixed to the side 62s of the mirror 62.

As shown in FIG. 6, the base member 70 includes a pair of openings 74 in addition to the above. The pair of openings 74 are formed in the substrate 70b. The pair of openings 74 are formed side by side in the x direction at a center portion of the base member 70 in the x direction. When viewed from the z direction, the outer shape of the opening 74 of the base member 70 is larger than the outer shape of the hand portion 64h of the intermediate member 64.

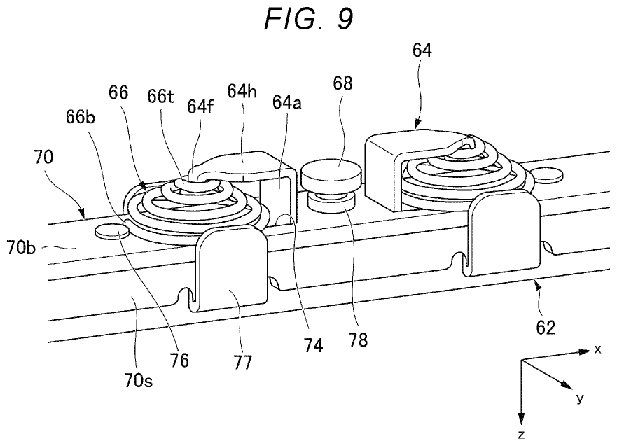

FIG. 9 is an enlarged view of the IX part of FIG. 5. The arm portion 64a of the intermediate member 64 extends to the back side of the base member 70 (in the −z direction) through the opening 74 of the base member 70. The hand portion 64h and the fingertip portion 64f of the intermediate member 64 are also disposed on the back side of the base member 70 (in the −z direction) through the opening part 74 of the base member 70.

The pair of coil springs 66 are disposed on the outer sides of the pair of arm portions 64a in the x direction. The pair of coil springs 66 are disposed on the back side of the base member 70. The pair of coil springs 66 are disposed between the pair of hand portions 64h of the intermediate member 64 and the substrate 70b of the base member 70 in the z direction. The coil diameter of the coil spring 66 is increased from a first end 66t in the −z direction to a second end 66b in the +z direction. Accordingly, when the coil spring 66 is compressed in the z direction, the coil spring 66 is crushed into a planar shape. When in a compressed state in the z direction, the coil spring 66 is inserted between the hand portion 64h and the base member 70 of the intermediate member 64. As a result, work for assembling the coil spring 66 is facilitated.

The first end 66t of the coil spring 66 is engaged with the fingertip portion 64f of the intermediate member 64. The fingertip portion 64f of the intermediate member 64 is inserted into an inner side of the first end 66t. As a result, the first end 66t is positioned in the x direction and the y direction.

The second end 66b of the coil spring 66 abuts against the base member 70. The outer shape of the second end 66b is larger than the outer shape of the opening 74 of the base member 70. The second end 66b is disposed across the opening 74.

In addition to the above, the base member 70 includes a first protrusion 76 and a second protrusion 77.

The first protrusion 76 protrudes from the substrate 70b in the −z direction. A pair of first protrusions 76 are disposed on the outer sides of the pair of openings 74 in the x direction.

The second protrusion 77 is formed by folding a portion of the widthwise bent portion 70s in the −z direction. A leading end of the second protrusion 77 protrudes from the substrate 70b in the −z direction. A pair of second protrusions 77 are disposed on both outer sides of the substrate 70b in the y direction.

The pair of first protrusions 76 are abuttable against the outer sides of the second ends 66b of the pair of coil springs 66 in the x direction. Further, the pair of coil springs 66 are disposed on the outer sides of the pair of arm portions 64a of the intermediate member 64 in the x direction. Accordingly, the pair of arm portions 64a are abuttable against the inner sides the second ends 66b of the pair of coil springs 66 in the x direction. As a result, the second ends 66b of the pair of coil springs 66 are positioned in the x direction.

The pair of second protrusions 77 are abuttable against the outer sides of the second ends 66b of coil springs 66 in the y direction. As a result, the second end 66b of the coil spring 66 is positioned in the y direction.

As shown in FIGS. 4 and 5, the movement mechanism 88 is disposed in the direction of the back side 62b of the mirror 62. The movement mechanism 88 moves the mirror 62 in the +y direction (in a direction away from the base member 70). The movement mechanism 88 includes a female screw 78 and a male screw 68.

As shown in FIG. 6, the female screw 78 is formed between the pair of openings 74 of the base member 70. The female screw 78 is formed by penetrating the substrate 70b of the base member 70 in the z direction.

The male screw 68 is threadingly engaged with the female screw 78 of the base member 70. The leading end 68t of the male screw 68 directly or indirectly abuts against the back side 62b of the mirror 62. The leading end 68t of the male screw 68 of the embodiment abuts against the bottom plate portion 64b of the intermediate member 64 . That is, the leading end 68t of the male screw 68 of the embodiment indirectly abuts against the back side 62b of the mirror 62 through the bottom plate portion 64b of the intermediate member 64.

The operation of the mirror device 60 for correcting the bending of the laser scanning line of the embodiment will be described.

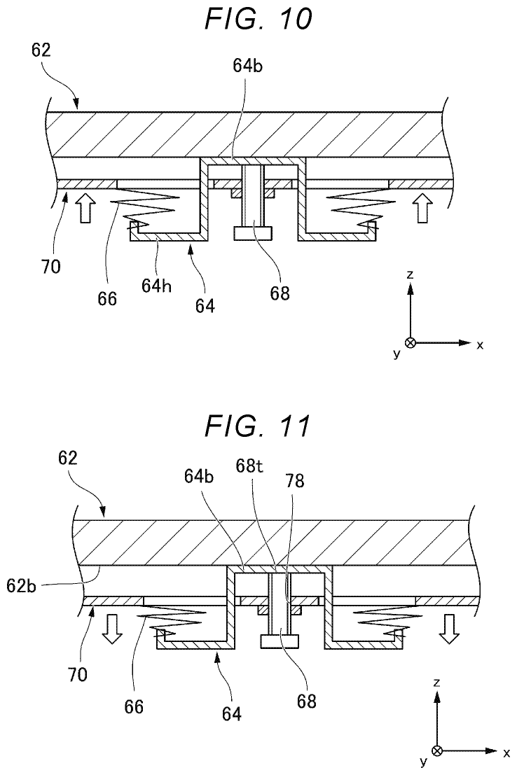

FIG. 10 is a first diagram of an operation of correcting laser scanning line. FIG. 11 is a second diagram of an operation of correcting laser scanning line. FIGS. 10 and 11 are enlarged views of a central portion of the mirror device 60 in the x direction, illustrating a cross section parallel to the xz plane of the mirror device 60 in the y direction.

As shown in FIG. 10, a pair of coil springs 66 are disposed on the back side of the base member 70 between the pair of hand portions 64h of the intermediate member 64 and the base member 70. The pair of coil springs 66 exert a biasing force such that the pair of hand portions 64h of the intermediate member 64 and the base member 70 are separated in the z direction. The bottom plate portion 64b of the intermediate member 64 is fixed to the center portion of the mirror 62 in the x direction. Both ends of the base member 70 in the x direction are fixed to the mirror 62 while being in a state of being separated from the mirror 62 by a predetermined distance in the z direction. The bending stiffness around the z axis is greater in the base member 70 than in the mirror 62. Accordingly, by the biasing force of the pair of coil springs 66, the center portion of the mirror 62 in the x direction approaches closer to the base member 70. That is, the mirror 62 bendably deforms to a convex shape in the −z direction. As a result, the laser scanning line of the laser scanning unit is corrected in a predetermined direction. In such a bending deformation of the mirror 62, the point of force of the external force corresponds to the center portion in the x direction at which the intermediate member 64 is fixed, and the fulcrum corresponds to the both ends in the x direction at which the base member 70 is fixed. The point of force and the fulcrum are disposed on the back side 62b or the side 62s of the mirror 62 and are not disposed on the reflective surface 62r.

As shown in FIG. 11, the male screw 68 is threadingly engaged with the female screw 78 of the base member 70. The leading end 68t of the male screw 68 indirectly abuts against the back side 62b of the mirror 62 through the bottom plate portion 64b of the intermediate member 64. When the male screw 68 is advanced in the +z direction, the center portion of the mirror 62 in the x direction is separated from the base member 70 against the biasing force of the pair of coil springs 66. That is, the mirror 62 bendably deforms to a convex shape in the +z direction. As a result, the bending of the laser scanning line of the laser scanning unit is corrected in the reverse direction, as shown in FIG. 10. In such a bending deformation of the mirror 62, the point of force of the external force corresponds to the center portion in the x direction against which the male screw 68 abuts, and the fulcrum corresponds to the both ends in the x direction at which the base member 70 is fixed. The point of force and the fulcrum are disposed on the back side 62b or the side 62s of the mirror 62 and are not disposed on the reflective surface 62r.

As described in detail above, the mirror device 60 of the embodiment includes a mirror 62, a base member 70, a fixing unit 73, a biasing mechanism 80, and a movement mechanism 88. The mirror 62 is in an elongated shape and has a reflective surface 62r. The base member 70 is an elongated member disposed on the back side 62b opposite to the reflective surface 62r. The fixing unit 73 fixes a portion of the mirror 62 excluding the reflective surface 62r to both ends of the base member 70 in the x direction. The biasing mechanism 80 is disposed on the back side 62b of the mirror 62 and biases the mirror 62 towards the base member 70. The movement mechanism 88 is disposed on the back side 62b of the mirror 62 and moves the mirror 62 in a direction away from the base member 70.

According to this arrangement, the base member 70, the biasing mechanism 80, and the movement mechanism 88 are disposed on the back side 62b of the mirror. In addition, the fixing unit 73 fixes a portion of the mirror 62 excluding the reflective surface 62r with the base member 70. Accordingly, the point of force of the external force and the fulcrum for the bending deformation of the mirror 62 are not disposed on the reflective surface 62r of the mirror 62. Therefore, the wider usable area of the reflective surface 62r of the mirror 62 can be secured.

The biasing mechanism 80 includes an intermediate member 64 and a biasing member 66. The intermediate member 64 is fixed to the back side 62b of the mirror 62 or the side 62s between the reflective surface 62r and the back side 62b, and extends to the back side of the base member 70 which is the side opposite to the mirror 62 with the base member 70 interposed therebetween. The biasing member 66 is disposed on the back side of the base member 70 between the intermediate member 64 and the base member 70.

According to this arrangement, the intermediate member 64 is fixed to the back side 62b or the side 62s of the mirror 62. In addition, the biasing member 66 is disposed on the back side of the base member 70. Accordingly, the point of force of the external force for the bending deformation of the mirror 62 is not disposed on the reflective surface 62r of the mirror 62. Therefore, the wider usable area of the reflective surface 62r of the mirror 62 can be secured.

The intermediate member 64 includes a pair of arm portions 64a, a pair of hand portions 64h, and a pair of fingertip portions 64f. The pair of arm portions 64a extend from the back side 62b of the mirror 62 through the opening 74 of the base member 70 to the back side of the base member 70. The pair of hand portions 64h extend from the leading ends of the pair of arm portions 64a to the outer sides of the pair of arm portions 64a. The pair of fingertip portions 64f protrude from the leading ends of the pair of hand portions 64h toward the base member 70. The biasing member includes a pair of coil springs 66 disposed between the pair of hand portions 64h and the base member 70 on the outer sides of the pair of arm portions 64a. The movement mechanism 88 is disposed in the inner sides of the pair of arm portions 64a.

According to this arrangement, the biasing mechanism 80 and the movement mechanism 88 are formed symmetrically with respect to the yz plane. Therefore, the mirror 62 bendably deforms symmetrically with respect to the yz plane.

The coil diameter of the pair of coil springs 66 is increased from a first end 66t to a second end 66b. The first end 66t is engaged with the pair of fingertip portions 64f. The second end 66b abuts against the base member 70.

According to this arrangement, the coil diameter of the coil spring 66 is increased from the first end 66t to the second end 66b. Accordingly, when the coil spring 66 is compressed, the coil spring 66 is crushed into a planar shape. Therefore, the work of inserting the coil spring 66 between the intermediate member 64 and the base member 70 is facilitated. In addition, the first end 66t is engaged with the pair of fingertip portions 64f . As a result, the first end 66t of the coil spring 66 is positioned.

The base member 70 includes a first protrusion 76 and a second protrusion 77 protruding to a side opposite to the mirror 62, with the base member 70 being interposed therebetween, which are abuttable against the second end 66b of the pair of coil springs 66.

With this arrangement, the second end 66b of the coil spring 66 is positioned.

The movement mechanism 88 includes a male screw 68. The male screw 68 is threadingly engaged with a female screw 78 formed on the base member 70, with the leading end 68t thereof directly or indirectly abutting against the back side 62b of the mirror 62.

According to this arrangement, the movement mechanism 88 is formed at a low cost.

The base member 70 includes lengthwise bent portions 71 which are bent at both ends in the x direction toward the mirror 62 side. The fixing unit 73 fixes the back side 62b and the lengthwise bent portion 71 of the mirror 62.

According to this arrangement, the base member 70 is disposed apart from the mirror 62 by the height of the lengthwise bent portion 71. In addition, the mirror 62 and the base member 70 are stably fixed through the lengthwise bent portion 71.

The base member 70 includes widthwise bent portions 70s which are bent at both ends in the y direction toward the mirror 62 side.

According to this arrangement, the second moment of area of the base member 70 increases and the bending stiffness increases. Therefore, the mirror 62 can be efficiently bendably deformed.

The leading end of the widthwise bent portion 70s overlaps with the side 62s between the reflective surface 62r and the back side 62b of the mirror 62.

According to this arrangement, the second moment of area of the base member 70 is further increased without increasing the size of the mirror device 60.

The fixing unit 73 fixes the side 62s of the mirror 62 with the widthwise bent portion 70s of the base member 70.

According to this arrangement, the mirror 62 and the base member 70 are more stably fixed.

In the laser scanning unit described above, the respective color optical systems are distributed on both sides in the Y direction of the polygon mirror 41. Meanwhile, the respective color optical systems may be disposed only on one side in the Y direction of the polygon mirror 41.

The intermediate member 64 of the mirror device 60 according to some embodiments extends through the opening 74 of the base member 70 to the back side of the base member 70. The intermediate member 64 may extend to the back side of the base member 70 through the outer side of the base member 70 in the y direction.

The fixing unit 73 of the mirror device 60 according to the embodiment fixes the base member 70 to the back side 62b and the side 62s of the mirror 62. The fixing unit 73 may fix the base member 70 only in the back side 62b of the mirror 62.

According to at least one embodiment described above, the base member 70, the biasing mechanism 80, and the movement mechanism 88 are disposed on the back side 62b of the mirror. In addition, the fixing unit 73 fixes the portion of the mirror 62 excluding the reflective surface 62r with the base member 70. As a result, the wider usable area of the reflective surface 62r of the mirror 62 can be secured.

What is claimed is:

1. A mirror device, comprising:
a mirror having an elongated shape and including a reflective surface;
a base member having an elongated shape disposed on a back side of the mirror opposite to the reflective surface,
a fixing unit configured to fix a portion of the mirror excluding the reflective surface to both ends of the base member in a lengthwise direction;
a biasing mechanism disposed on the back side of the mirror and biasing the mirror towards the base member; and
a movement mechanism disposed on the back side of the mirror and moving the mirror in a direction away from the base member.

2. The mirror device of claim 1, wherein
the movement mechanism includes a male screw, and
the male screw is threadingly engaged with a female screw formed on the base member with a leading end of the male screw directly or indirectly abutting against the back side of the mirror.

3. The mirror device of claim 1, wherein
the biasing mechanism includes an intermediate member and a biasing member,
the intermediate member is fixed to the back side of the mirror or a side of the mirror between the reflective surface and the back side, and extends to a backside of the base member opposite to the mirror with the base member interposed between the mirror and the intermediate member, and
the biasing member is disposed on the back side of the base member between the intermediate member and the base member.

4. The mirror device of claim 3, wherein the intermediate member is fixed to the back side of the mirror via an adhesive.

5. The mirror device of claim 3, wherein
the intermediate member includes a pair of arm portions, a pair of hand portions, and a pair of fingertip portions,
the pair of arm portions extend from the back side of the mirror through an opening of the base member to the back side of the base member,
the pair of hand portions extend from leading ends of the pair of arm portions to outer sides of the pair of arm portions,
the pair of fingertip portions protrude from leading ends of the pair of hand portions toward the base member,
the biasing member includes a pair of coil springs disposed on the outer sides of the pair of arm portions between
the pair of hand portions and the base member, and the movement mechanism is disposed in inner sides of the pair of arm portions.

6. The mirror device of claim 5, wherein
the pair of coil springs have a coil diameter increasing from first ends to second ends of the coil springs, the first ends are engaged with the pair of fingertip portions, and the second ends abut against the base member.

7. The mirror device of claim 6, wherein
the base member includes a protrusion protruding to a side opposite to the mirror, with the base member being interposed between the protrusion and the base member, the protrusion being abuttable against the second ends of the pair of coil springs.

8. The mirror device of claim 5, wherein
the movement mechanism includes a male screw, and
the male screw is threadingly engaged with a female screw formed on the base member with a leading end of the male screw directly or indirectly abutting against the back side of the mirror.

9. The mirror device of claim 1, wherein
the base member includes a first bent portion bent at both ends of the base member in the lengthwise direction toward the mirror side, and
the fixing unit is configured to fix the back side of the mirror with the first bent portion.

10. The mirror device of claim 1, wherein
the base member includes a second bent portion bent at both ends of the base member in a width direction toward the mirror side.

11. The mirror device of claim 10, wherein
a leading end of the second bent portion overlaps with a side of the mirror between the reflective surface and the back side of the mirror.

12. The mirror device of claim 11, wherein
the fixing unit is configured to fix the side of the mirror with the second bent portion.

13. The mirror device of claim 1, wherein the base member has a U-shaped cross-section perpendicular to the lengthwise direction.

14. The mirror device of claim 1, wherein the base member comprises a steel material.

15. The mirror device of claim 1, wherein the fixing unit is configured to fix only the back side of the mirror to both ends of the base member in a lengthwise direction.

16. The mirror device of claim 1, wherein the fixing unit is configured to fix the portion of the mirror excluding the reflective surface to both ends of the base member via an adhesive.
